(19) United States
(12) Patent Application Publication
(10) Pub. No.: US 2012/0095132 A1
(43) Pub. Date: Apr. 19, 2012

(54) HALOGEN- AND PHOSPHORUS-FREE THERMOSETTING RESIN COMPOSITION

(76) Inventors: Chung-Hao CHANG, Taoyuan Hsien (TW); Chia-Hsiu Yeh, Taoyuan Hsien (TW); Hui-Min Lin, Taoyuan Hsien (TW)

(21) Appl. No.: 12/907,364

(22) Filed: Oct. 19, 2010

(51) Int. Cl. C08L 63/02

(52) U.S. Cl. 523/429

(57) ABSTRACT

A halogen- and phosphorus-free thermosetting resin composition is provided, which is mainly a varnish resin formed by mixing a mixture of two curing agents, an epoxy resin mixture, and an inorganic additive. The mixture of two curing agents is formed by mixing a phenolphthalein modified benzoxazine phenol aldehyde curing agent and an amino triazine novolak, and the epoxy resin mixture is formed by mixing an epoxy resin having an oxazolidone ring or a polyamide-imide-modified epoxy resin and a Bisphenol F epoxy resin.

### BACKGROUND OF THE INVENTION

1. Field of Invention

The present invention relates to a halogen- and phosphorus-free thermosetting resin composition. A cured product of the composition has flame retardant property, as well as excellent electrical and mechanical properties, including, for example, low dissipation factor, low expansion coefficient, and good thermal stability. A semi-cured impregnated material and the cured material of the composition of the present invention is free of halogen and phosphorus flame retardant, and will not produce toxic gases in combustion and will not cause environment pollution (no phosphide precipitation) in hydrolysis, and thus being widely used in printed circuit laminates (containing a semi-cured impregnated material), binding agents for adding layer, adhesives, package materials, and FRP products.

2. Related Art

Printed circuit boards (PCBs) are main supporting for electronic components, and with the development of PCB technologies (high-density wiring, thin form, fine pore size, highly dimensional stability, and high heat dissipation performance), the material for PCB is developed from a conventional FR-4 (generally referring to a resin composition with Dicy as curing agent) to an FR-4 material meeting the requirements of a lead-free process, and a green and environment-friendly FR-4 material. The main flame retardant property of a resin currently used as the FR-4 material is imparted by an epoxy resin containing halogen or phosphorus. Furthermore, the conventional FR-4 material has the disadvantage of poor thermal stability, and cannot meet the requirements of the lead-free process, while the FR-4 materials from the lead-free and environment-friendly processes also have the disadvantages of poor PCB processability and signal transmission loss. Therefore, development of a new generation environment-friendly material that meets the requirements of the lead-free process and environment-friendly, and has good PCB processability, good thermal stability, and good signal transmission has become a business opportunity with great potential.

It is found through researches that the epoxy resin containing halogen, as a flame retardant, may produce harmful carcinogenic gases such as toxic dioxin and furan at an unsuitable combustion temperature (<1000° C.), and in recent years, with increasing awareness of environmental protection, in addition to quite strict requirements for fire safety, considerable attentions are paid on environmental protection. Considering the flame retardant safety, the requirements of environment-friendly materials, and business opportunity and strategy, development of new generation of environment-friendly and halogen-free PCBs, that is, the so-called halogen-free materials, are actively carried out in many countries.

Presently, the flame retardant function of the materials of the halogen-free PCBs is mainly achieved by a phosphorus-containing flame retardant in place of a brominated epoxy resin. Although the phosphorus-containing flame retardant technology can effectively replace the conventional halogen-containing flame retardant, the phosphorus-containing flame retardant will cause river or lake eutrophication due to hydrolysis, and thus leading to another environmental issue. At the same time, the phosphorus-containing flame retardant will cause a decreased or failed long-term reliability of electronic products due to high water adsorption and disassociation properties. Therefore, the main manufactures of electronic package materials in the world have actively endeavored to develop a halogen- and phosphorus-free substrate composition system having flame retarding property. Now, there are prototype products available in Japan and America, which are expected to gradually replace the existing phosphorus-containing flame retardant material system and become popular in the market in the next 2-5 years.

In halogen- and phosphorus-free flame retardant resin compositions currently used in industry, an epoxy resin is used as the main component, to a fabricate halogen- and phosphorus-free copper foil substrate or resin coated copper foil substrate together with a flame retardant Melamine Cyanurate (MC-610), Bis(3-ethyl-5-methyl-maleimidophenyl) Methane Polyethersulfone, or polyamideimide. However, the price of the material of these flame retardants is relatively high, and thus causing the increase of the production cost, and there is also derivative problems such as poor PCB processability. Furthermore, in use of a polycyclic polyamideimide as flame retardant, in addition to the disadvantage of the poor PCB processability of the material, the stability of the modified epoxy resin containing nitrogen synthesized thereby is not good, such that the basic properties, such as low dissipation factor and low expansion coefficient, of the material of the PCB are not obvious.

In view of this, the resin material is developed toward the direction of being free of halogen and phosphorus, improving the electrical and mechanical properties of the material, and improving the PCB processability, such that the present invention is generated to meet the requirements of being green and environment-friendly, light, thin, short, and small of electronic products, high speed of cloud computing technology, and high-speed integration of a micro-system products.

### SUMMARY OF THE INVENTION

The present invention is mainly directed to a halogen- and phosphorus flame retardant-free thermosetting resin composition; semi-cured (B-stage) and cured (C-stage) products of the composition have the advantage of not causing environment pollution, and thus being widely used as the material for PCB or IC package substrate.

The present invention is further directed to a resin composition having excellent electrical and mechanical properties, which have critical characteristics that are necessary for next-generation electronic products, such as low dissipation factor, low expansion coefficient, and high peel strength of copper foil, and thus providing an effective solution for the next-generation electronic products.

In order to achieve the above objectives, the present invention provides a halogen- and phosphorus-free thermosetting resin composition, which is mainly a varnish resin formed by mixing a mixture of two curing agents, an epoxy resin mixture, and an inorganic additive, in which the mixture of two curing agents is formed by mixing a phenolphthalein modified benzoxazine phenol aldehyde curing agent and amino triazine novolak, and the epoxy resin mixture is formed by mixing an epoxy resin having an oxazolidone ring or a polyamide-imide-modified epoxy resin and Bisphenol F epoxy resin.

In implementation, the epoxy resin having an oxazolidone has an epoxy equivalent of 250-800.

In implementation, the inorganic additive is selected from silica, titania, alumina, zinc borate, alumina hydroxide, aluminum hydroxide, magnesium hydroxide, calcium carbonate, aluminum nitride, boron nitride, alumina, silver, aluminum, zinc oxide, nano-carbon tube and a mixture thereof, and has an average particle size in a range of 0.01 μm to 10 μm.

In implementation, the Bisphenol F epoxy resin has an epoxy equivalent of 160-1000.

In implementation, the polyamide-imide-modified epoxy resin has an epoxy equivalent of 300 to 1000.

In implementation, 0.01-3 wt % of a catalyst is further added, in which the catalyst is an imidazole catalyst.

In implementation, 0.01-1.0 wt % of a flow modifier is further added, in which the flow modifier is an acrylic acid copolymer or a modified acrylic acid copolymer having an average molecular weight of 5,000-200,000.

In order to make the present invention more comprehensible, the present invention is described in detail with reference to an embodiment below.

### BRIEF DESCRIPTION OF THE DRAWINGS

The present invention will become more fully understood from the detailed description given herein below for illustration only, and thus are not limitative of the present invention, and wherein:

FIG. 1 is a schematic view showing components of a halogen- and phosphorus-free thermosetting resin composition of the present invention.

### DETAILED DESCRIPTION OF THE INVENTION

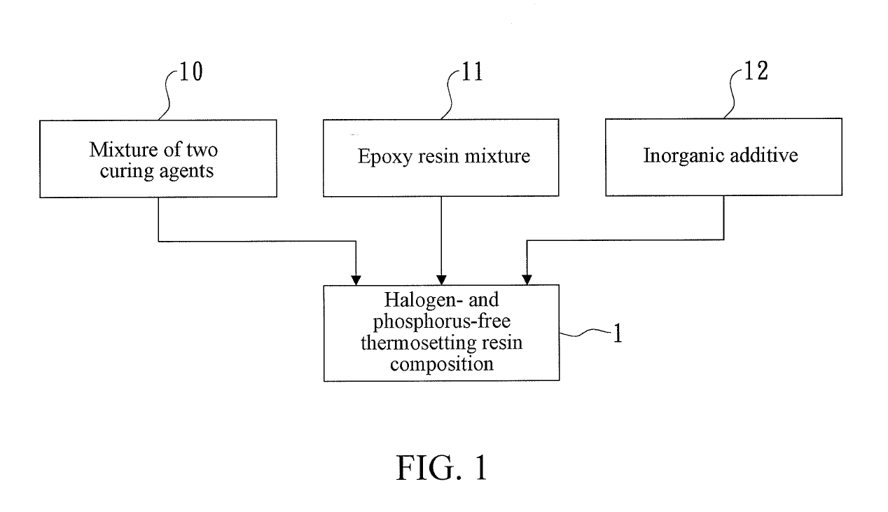

FIG. 1 is a schematic view showing components of a halogen- and phosphorus-free thermosetting resin composition 1 of the present invention. As shown in FIG. 1, the thermosetting resin composition 1 is mainly a varnish resin formed by mixing a mixture 10 of two curing agents, an epoxy resin mixture 11, and an inorganic additive 12.

The mixture 10 of two curing agents is formed by mixing a phenolphthalein modified benzoxazine phenol aldehyde curing agent and amino triazine novolak, and the epoxy resin mixture 11 is formed by mixing an epoxy resin having an oxazolidone ring or a polyamide-imide-modified epoxy resin and Bisphenol F epoxy resin.

The amino triazine novolak has a structural formula below:

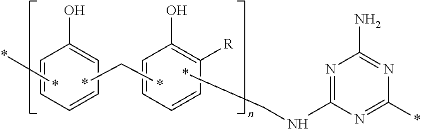

in which R is —H or —CH₃, and n is an integer of 1-10; a —OH value of 120-500, and a nitrogen content of 8-30%.

The phenolphthalein modified benzoxazine phenol aldehyde curing agent has a structural formula below:

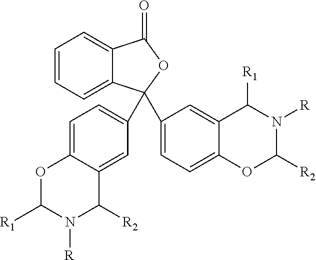

in which R is allyl, an unsubstituted or substituted phenyl, an unsubstituted or substituted C₁-C₈ alkyl, or an unsubstituted or substituted C₃-C₈ cycloalkyl, and R₁ and R₂ are an aromatic compound or an aliphatic compound, and preferably —CH₃; a —OH value of 200-700, and a nitrogen content of 5-15%.

The epoxy resin having an oxazolidone ring has a structural formula below:

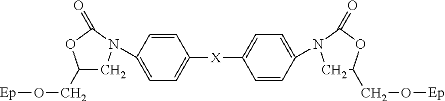

in which Ep represents an epoxy group, and X is —CH₂; an epoxy equivalent of 250-800, and a nitrogen content of 2-10%.

The polyamide-imide-modified epoxy resin has a structural formula below:

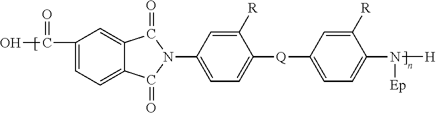

in which, R is an aromatic compound or an aliphatic compound;

Q is—, —CH₂—, —C(CH₃)₂—, —O—, —S—, or —SO₂—; and

n is an integer, and 0<n<80, and Ep has one of the following two structures:

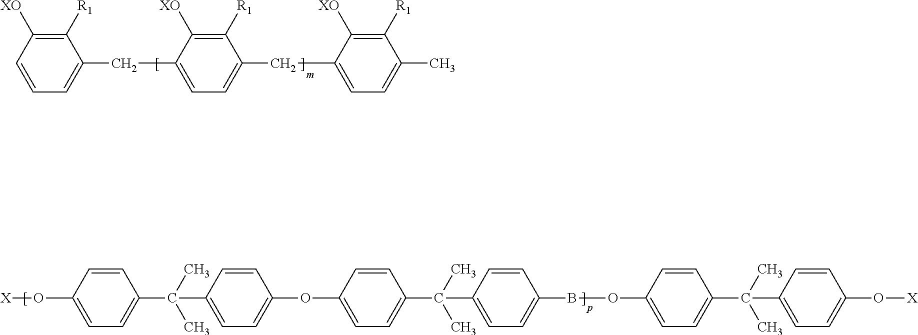

in which, m=1-11(integer);
p=1-11(integer);
R₁=—CH₃ or —H; and
X=A or B.

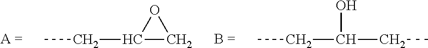

The polyamide-imide-modified epoxy resin has an epoxy equivalent of 300-1000.

The Bisphenol F epoxy resin has an epoxy equivalent of 160-1000. The inorganic additive 12 is selected from silica, titania, alumina, zinc borate, alumina hydroxide, aluminum hydroxide, magnesium hydroxide, calcium carbonate, aluminum nitride, boron nitride, alumina, silver, aluminum, zinc oxide, nano-carbon tube and a mixture thereof, and has an average particle size in a range of 0.01 μm to 10 μm.

Therefore, in implementation of the present invention, as shown in a table below, 5-20% of a mixture of two curing agents containing a phenolphthalein modified benzoxazine phenol aldehyde curing agent and amino triazine novolak, 35-70% of an epoxy resin mixture of an epoxy resin having an oxazolidone ring and Bisphenol F epoxy resin, and 25-45% of an inorganic additive, or 30-50% of a mixture of two curing agents containing a phenolphthalein modified benzoxazine phenol aldehyde curing agent and amino triazine novolak, 15-60% of an epoxy resin mixture of a polyamide-imide-modified epoxy resin or Bisphenol F epoxy resin, and 10-35% of an inorganic additive may be formulated.

| | Formulation | | | |
|---|---|---|---|---|
| | 1 | 2 | 3 | 4 |
| Polyamide-imide-modified epoxy | 0 | 0 | 7 | 51 |
| resin | | | | |
| Epoxy resin having an oxazolidone | 10 | 5 | 0 | 0 |
| ring | | | | |
| Bisphenol F epoxy resin | 25 | 65 | 8 | 9 |
| Epoxy resin (%) | 35 | 70 | 15 | 60 |
| Amino triazine novolak | 10 | 2 | 19 | 9 |
| Phenolphthalein modified | 10 | 3 | 31 | 21 |
| benzoxazine Phenol aldehyde | | | | |
| Curing agent (%) | 20 | 5 | 50 | 30 |
| SiO₂/Al(OH)₃/AlOOH/Mg(OH)₂ | 45 | 25 | 35 | 10 |
| mixture | | | | |
| Inorganic additive (%) | 45 | 25 | 35 | 10 |
| Flame retardancy | V-0 | V-0 | V-0 | V-0 |
| Thermal stability (T-288; min) | >10 | >10 | >15 | >15 |
| Dissipation factor (@ 1 GHz) | 0.006 | 0.007 | 0.007 | 0.008 |
| Thermal expansion coefficient | 42 | 42 | 40 | 40 |
| (×10⁻⁶/° C.) | | | | |
| Adhesion strength (1 oz Cu Foil; | 8.5 | 8.5 | 9.1 | 9.2 |
| lb/in) | | | | |

Furthermore, the halogen- and phosphorus-free thermosetting resin composition of the present invention further includes 0.01-3% of a catalyst, which is an imidazole catalyst, and 0.01-1.0% of a flow modifier, which is an acrylic acid copolymer or a modified acrylic acid copolymer having an average molecular weight of 5,000-200,000.

Therefore, the present invention has the following advantages.

1. The halogen- and phosphorus-free thermosetting resin composition of the present invention contains no phosphorus flame retardants, and will not cause problems of environmental protection in hydrolysis, and does not have high water adsorption and disassociation properties, and thus being capable of improving the reliability of electronic products in use.

2. The halogen- and phosphorus-free thermosetting resin composition of the present invention has reactivity comparable to that of current materials of printed circuit boards, and thus having no disadvantage of low reactivity.

3. The halogen- and phosphorus-free thermosetting resin composition of the present invention has excellent flame retardancy, and thus meeting the properties of UL 94-V0 for current FR-4 materials.

4. After the mixture of two curing agents reacts with the epoxy resins, the composition of the present invention has a high cross-linking density, and has no hydroxyl group (—OH) of high polarity formed upon curing, such that a cured product has characteristics of flame retardancy, low expansion coefficient, low dissipation factor, good rheological property, good thermal stability, and good adhesion strength with metal foil, and thus the composition of the present invention is capable of providing good signal transmission quality and electrical and mechanical functions to electronic products when being used as a material for a high frequency, multi-layer or high-density interconnected PCB.

5. The halogen- and phosphorus-free thermosetting resin composition of the present invention uses low-cost materials, and thus has advantages in competition in industry.

6. The halogen- and phosphorus-free thermosetting resin composition of the present invention has extremely high compatibility with the current PCB fabrication process, and thus can directly replace the current material of PCBs, without significantly changing the process and equipments, and thereby having very wide application in industry.

While the present invention has been described with reference to the embodiments and technical means thereof, various changes and modifications can be made based on the disclosure or teachings described herein. Any equivalent changes made based on the concepts of the present invention having their effect without departing from the spirit encompassed by the specification and drawings should be construed as falling within the scope of the invention as defined by the appended claims.

According to the aforementioned disclosure, the present invention surely can achieve the expected objectives to provide a halogen- and phosphorus-free thermosetting resin composition, which has industrial applicability. Thus, the application for a patent is filed according to the law.

What is claimed is:

1. A halogen- and phosphorus-free thermosetting resin composition, comprising:
5-20% of a mixture of two curing agents comprising a phenolphthalein modified benzoxazine phenol aldehyde curing agent and amino triazine novolak, 35-70% of an epoxy resin mixture of an epoxy resin having an oxazolidone ring and Bisphenol F epoxy resin, and 25-45% of an inorganic additive, to form a varnish resin.

2. The halogen- and phosphorus-free thermosetting resin composition according to claim 1, wherein the epoxy resin having an oxazolidone ring has a structural formula below: 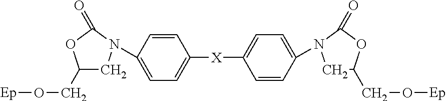
in which Ep represents an epoxy group; an epoxy equivalent of 250-800, and a nitrogen content of 2-10%.

3. The halogen- and phosphorus-free thermosetting resin composition according to claim 1, wherein the amino triazine novolak has a structural formula below: 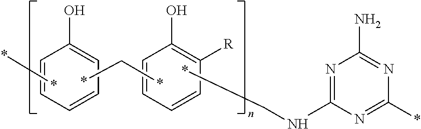
in which R is —H or —CH₃, and n is an integer of 1-10, a —OH value of 120-500, and a nitrogen content of 8-30%.

4. The halogen- and phosphorus-free thermosetting resin composition according to claim 1, wherein the phenolphthalein modified benzoxazine phenol aldehyde curing agent has a structural formula below: 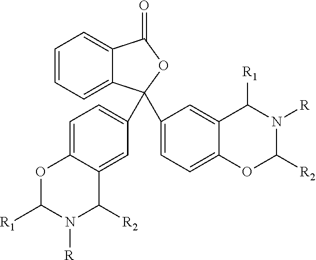
in which R is allyl, an unsubstituted or substituted phenyl, an unsubstituted or substituted C₁-C₈ alkyl, or an un substituted or substituted C₃-C₈ cycloalkyl, and R₁ and R₂ are an aromatic compound or an aliphatic compound.

5. The halogen- and phosphorus-free thermosetting resin composition according to claim 4, wherein the phenolphthalein modified benzoxazine phenol aldehyde curing agent has a —OH value of 200-700, and a nitrogen content of 5-15%.

6. The halogen- and phosphorus-free thermosetting resin composition according to claim 1, wherein the Bisphenol F epoxy resin has an epoxy equivalent of 160-1000.

7. The halogen- and phosphorus-free thermosetting resin composition according to claim 1, wherein the inorganic additive is selected from silica, titania, alumina, zinc borate, alumina hydroxide, aluminum hydroxide, magnesium hydroxide, calcium carbonate, aluminum nitride, boron nitride, alumina, silver, aluminum, zinc oxide, nano-carbon tube and a mixture thereof, and has an average particle size ranging from 0.01 μm to 10 μm.

8. The halogen- and phosphorus-free thermosetting resin composition according to claim 1, further comprising 0.01-3 wt % of a catalyst added, wherein the catalyst is an imidazole catalyst.

9. The halogen- and phosphorus-free thermosetting resin composition according to claim 1, further comprising 0.01-1.0 wt % of a flow modifier added, wherein the flow modifier is an acrylic acid copolymer or a modified acrylic acid copolymer having an average molecular weight of 5,000-200,000.

10. A halogen- and phosphorus-free thermosetting resin composition, comprising:
30-50% of a mixture of two curing agents comprising a phenolphthalein modified benzoxazine phenol aldehyde curing agent and amino triazine novolak, 15-60% of an epoxy resin mixture of a polyamide-imide-modified epoxy resin or Bisphenol F epoxy resin, and 10-35% of an inorganic additive, to form a varnish resin.

11. The halogen- and phosphorus-free thermosetting resin composition according to claim 10, wherein the epoxy resin having an oxazolidone ring has a structural formula below: 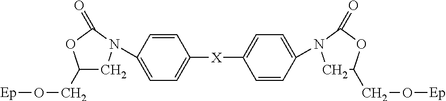
in which Ep represents an epoxy group; an epoxy equivalent of 250-800, and a nitrogen content of 2-10%.

12. The halogen- and phosphorus-free thermosetting resin composition according to claim 10, wherein the amino triazine novolak has a structural formula below: 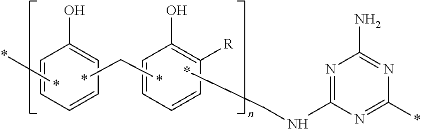
in which R is —H or —CH₃, and n is an integer of 1-10, a —OH value of 120-500, and a nitrogen content of 8-30%.

13. The halogen- and phosphorus-free thermosetting resin composition according to claim 10, wherein the phenolphthalein modified benzoxazine phenol aldehyde curing agent has a structural formula below: 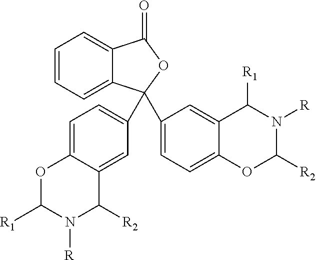
in which R is allyl, an unsubstituted or substituted phenyl, an unsubstituted or substituted C₁-C₈ alkyl, or an un substituted or substituted C₃-C₈ cycloalkyl, and R₁ and R₂ are an aromatic compound or an aliphatic compound.

14. The halogen- and phosphorus-free thermosetting resin composition according to claim 13, wherein the phenolphthalein modified benzoxazine phenol aldehyde curing agent has a —OH value of 200-700, and a nitrogen content of 5-15%.

15. The halogen- and phosphorus-free thermosetting resin composition according to claim 10, wherein the Bisphenol F epoxy resin has an epoxy equivalent of 160-1000.

16. The halogen- and phosphorus-free thermosetting resin composition according to claim 10, wherein the inorganic additive is selected from silica, titania, alumina, zinc borate, alumina hydroxide, aluminum hydroxide, magnesium hydroxide, calcium carbonate, aluminum nitride, boron nitride, alumina, silver, aluminum, zinc oxide, nano-carbon tube and a mixture thereof, and has an average particle size ranging from 0.01 μm to 10 μm.

17. The halogen- and phosphorus-free thermosetting resin composition according to claim 10, further comprising 0.01-3 wt % of a catalyst added, wherein the catalyst is an imidazole catalyst.

18. The halogen- and phosphorus-free thermosetting resin composition according to claim 10, further comprising 0.01-1.0 wt % of a flow modifier added, wherein the flow modifier is an acrylic acid copolymer or a modified acrylic acid copolymer having an average molecular weight of 5,000-200,000.

19. The halogen- and phosphorus-free thermosetting resin composition according to claim 10, wherein the polyamide-imide-modified epoxy resin has a structural formula below: 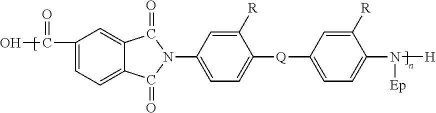
in which, R is an aromatic compound or an aliphatic compound;
Q is—, —CH₂—, —C(CH₃)₂—, —O—, —S—, or —SO₂—; and
n is an integer and 0<n<80, and Ep has one of the following two structures: 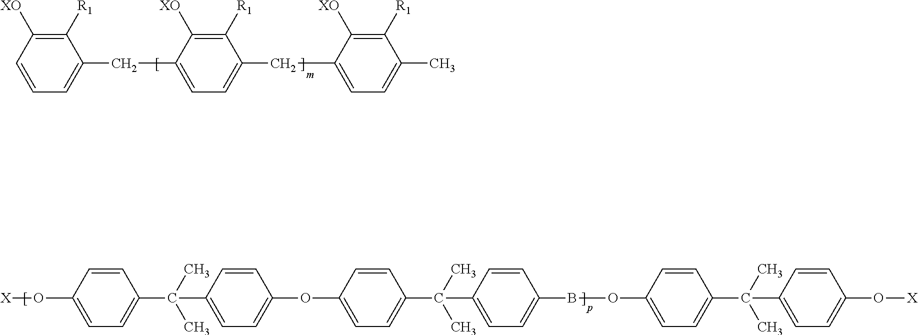
in which, m=1-11 (integer); p=1-11 (integer);
R₁=—CH₃ or —H; and
X=A or B.

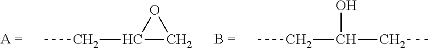

20. The halogen- and phosphorus-free thermosetting resin composition according to claim 10, wherein the polyamide-imide-modified epoxy resin has an epoxy equivalent of 300 to 1000.
